(19) United States
(12) Patent Application Publication
(10) Pub. No.: US 2004/0206294 A1
(43) Pub. Date: Oct. 21, 2004

(54) Trail marking device

(76) Inventor: George Cavanaugh, Broomfield, CO (US)

Correspondence Address: Boyd D. Cox, Suite 506, 75 N. East Avenue, Fayetteville, AR, 72701, US

(21) Appl. No.: 10/417,833

(22) Filed: Apr. 16, 2003

(51) Int. Cl. G01D 21/00

(52) U.S. Cl. 116/209; 116/DIG. 14

(57) ABSTRACT

A trail marking device includes an elongated sheet of pliable tape having at least one surface with first and second sections being formed by illuminative material and brightly colored material, respectively. The illuminative material and brightly colored material of the first and section sections are formed in a pattern of diagonals on the tape which is readily visible during both day and night times.

### BACKGROUND

The present invention is directed to a trail marking device which provides a positive marking for a trail which is highly visible in both daytime and nighttime hours for guiding a person along that trail.

When hiking in unfamiliar woods or in other unknown areas, it is easy for one to become disoriented and have difficulty finding his or her way back to safety. Whether retracing one's path or hiking a new trail, having a clearly marked path makes it easier for the traveler to avoid the dangers of getting lost.

Many hikers tend to rely on their sense of direction and memory when traveling in the woods. Generally one's sense of direction and memory is aligned with visual clues along the route. For example, by consulting the sun one can determine the general direction of travel. However, on cloudy days when the sun is not visible or at night, one cannot rely on the sun's position to maintain a sense of direction.

By committing visual landmarks to memory, hikers can sometimes retrace their paths through the woods and avoid getting lost. However, it is common to discover that such landmarks are completely unrecognizable when approached from the opposite direction. Not recognizing or not remembering the landmarks can cause confusion and result in getting lost, especially in an unfamiliar area.

Other means, such as breaking limbs to mark trails have been used by hikers to create recognizable signposts along their paths. In addition, other natural materials such as rocks, leaves or sticks, found in the surrounding environment are often positioned by a hiker to form a recognizable sign to guide him when retracing a trail. Such natural materials do not provide a positive or permanent marking means because they have a tendency to lose their identity when used in their natural setting. As a result, they can be easily overlooked by one traveling through the woods. In addition, such materials can easily shift or deconstruct over the course of time and therefore fail to provide a durable and lasting means for marking trails.

Many public hiking trails are positively marked by paint. Strips of paint are applied to trees and rocks for markings to guide hikers along the trail. This provides an unmistakable or positive means for marking trails, however, there are certain drawbacks associated with using paint. The paint is applied to materials in their natural environment and cannot be easily removed once it has been applied. Furthermore, paint is not highly visible at night or during inclement weather such as rain or fog. In addition, applying paint markers in remote areas can be a cumbersome process requiring that a hiker carry paint and a paint applicator, such as a paint brush. This not only creates undue weight for a hiker, but also creates difficulty in traveling with a wet paintbrush.

Plastic tape is a marking device used by surveyor's to indicate the points of a survey. The tape is generally tied to trees, limbs, or stakes indicating where critical points of the survey are located. Surveyor's tape is generally brightly colored and therefore highly visible in daylight hours. However, the brightly colored tape cannot be readily seen during nighttime hours.

It has been found that combining a luminescent surface and a brightly colored surface on a trail marker renders that marker visible during both daylight and darkness. However, such markers can be twisted and/or rolled during or after installation such that one or the other of the brightly colored or luminescent surfaces of the marker is obscured. With one of the luminescent or brightly colored surfaces not visible, the effectiveness of the marker is significantly diminished for respective daytime or nighttime visibility.

For the foregoing reasons, there is a need for a trail marking device that is positively and clearly identifiable during both daytime and nighttime hours, regardless of twisting, rolling or position changing of the marker. There is a further need for a trail marking device that is lightweight and durable, yet can be easily installed and removed without altering or damaging the natural surroundings in which the device is used.

### SUMMARY

The present invention is directed to a trail marking device that is highly visible during daytime and nighttime hours and that retains its visual integrity for a considerable length of time despite shifts in the position of the tape. The device comprises an elongated sheet of pliable tape having a specific pattern on at least one of its surfaces. The specific pattern includes a first section comprising a brightly colored material that is highly visible during the day and a second section comprising an illuminative material that is highly visible during the night. These first and second sections are alternately disposed along a length of the tape and extend diagonally across the tape's width.

During installation or extended use, the tape may become twisted, rolled or compressed. The pattern on the surface of the tape increases the probability that both of the luminescent sections and the highly reflective sections will remain visible to an observer.

It is an object of the present invention to provide a trail marking device that can be easily seen in both daytime and nighttime hours.

It is a further object of the present invention to provide a trail marking device that can be made to a desired size without the use of cutting tools.

It is a further object of the present invention to provide a trail marking device that remains readily visible both day and night for an extended period of time.

It is a further object of the present invention to provide a trail marking device that includes a sheet of tape having a surface forming a pattern that alternates from a section that is highly visible during the day to a section that is highly visible during the night.

It is a further object of the present invention to provide trail marking tape that remains visible during daytime and nighttime hours when the tape is twisted, rolled and or compressed.

It is a further object of the present invention to provide an inexpensive means for marking wilderness trails in a positive and substantially permanent manner.

It is a further object of the present invention to provide a trail marking device that is light weight and compact.

It is a further object of the present invention to provide a trail marking device that can be readily installed by users without the use of tools.

It is a further object of the present invention to provide a trail marking device that can be used to permanently mark trails through wilderness areas and which can be easily removed when desired.

It is a further object of the present invention to provide an inexpensive trail marking device that is highly visible over long distances both day and night.

### BRIEF DESCRIPTION OF DRAWINGS

Reference is made to the accompanying drawings in which are shown illustrative embodiments of the invention and from which novel features and advantages will be apparent.

FIG. 1 is a perspective view of a preferred embodiment of the trail marking device of the present invention showing a sheet of tape wound on the storage spool.

FIG. 2 is a top view showing a selected portion of the tape of FIG. 1.

FIG. 3A shows the tape of FIG. 1 installed on a vertically disposed tree trunk.

FIG. 3B shows the tape of FIG. 1 installed on a horizontally extending tree branch.

### DETAILED DESCRIPTION

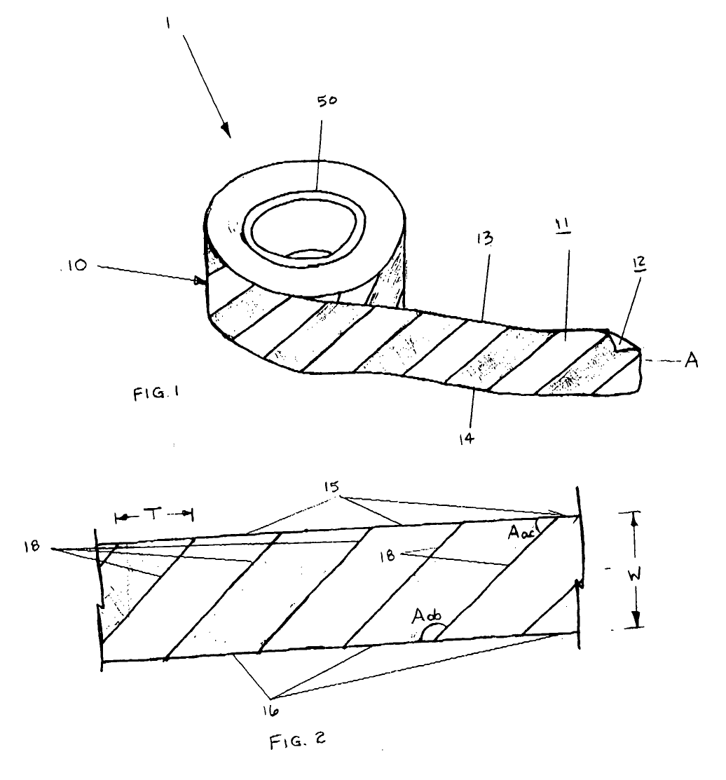

Referring to the drawings, there is shown a trail marking device 1 in FIGS. 1 and 2 comprising an elongated sheet of pliable tape 10. The tape 10 is initially wound onto a storage spool 50 and is removed as needed.

The sheet of tape 10 is characterized by front 11 and back 12 surfaces. First 13 and second 14 edges define the sides of the sheet of tape 10. The front surface 11 is comprised by a plurality of sections that include first 15 and second sections 16. The first section 15 comprises an illuminative material that is highly visible during the night, such as a light reflective material or a light emitting material, including luminescent and phosphorescent materials. The second section 16 comprises a brightly colored material that is highly visible during the day, such as a fluorescent colored material.

The tape 10 has a longitudinal axis A that extends generally parallel to the first 13 and second 14 edges. The length of the tape 10 is selective and can be varied. The length of a selected portion 17 is measured along the longitudinal axis A of the tape 10. A specified width W spans the shortest distance between the first 13 and second 14 edges, intersecting the longitudinal axis A. Each of the first 15 and second 16 sections extends diagonally across the width W of the tape 10 and has a generally parallelogram shape.

In a preferred embodiment, the tape 10 comprises a pliable plastic such as polyvinyl sheeting, although other types of suitable plastic or material could be used instead. Being pliable allows the tape 10 to be wrapped around differently sized and shaped supports. The tape 10 can also be readily manipulated and knotted while remaining intact. Although the selected portions 17 of the tape 10 can be any length, it is preferably elongated to facilitate its being wrapped around a tree trunk, limb or other support and the ends tied together to secure the tape 10 in place.

The brightly colored second sections 16 enhance visibility of the tape 10 during the daylight hours. Since the illuminative material of the first section 15 readily reflects or emits light, these sections 15 are highly visible at night. Together both of the first 15 and second 16 sections make the tape 10 readily visible during all hours of the day and night.

The pattern formed by the first 15 and second 16 sections on the front surface 11 of the tape 10 contributes to the tape's overall visibility. The tape 10 can get twisted, compressed and/or rolled, sometimes leaving only a thin strip of the tape 10 exposed. Due to the diagonal pattern of the alternating colors displayed across the front surface 11 of the tape 10, both the first 15 and second 16 sections can remain visible. Therefore, despite occasions when the tape is not lying flat, the pattern enables continued visibility of the first 15 and second 16 sections.

It can be appreciated that twisting, rolling and compressing can happen to the tape during installation, as a result of vandalism or by natural causes. The tape 10 of the present invention has an increased probability that both of the different colored first 15 and second 16 sections are still visible when that occurs and the tape 10 is still visible in both day and night.

In the trail marking device 1 of the present invention, it is preferred that the pliable tape 10 is stored on the spool 50 until the tape 10 is needed. The first sections 15 and second sections 16 are adjacent to each other and alternate with each other along the longitudinal axis of the tape 10.

The width W of the tape 10 is predetermined and is approximately 1.25 inches. While this is preferred, the width W of the tape 10 could vary within a range that still would allow the ends of a selected portion of tape 10 to be tied to a support. The length of each selected portion of tape 10 can be varied as determined by a user. The length is generally selected according to various factors, including the size and/or the location of the support onto which the tape 10 is to be installed.

Preferably, all of the first 15 and second 16 sections are approximately the same size, with a thickness T of about 0.5 inches. However, the sizes of the sections 15,16 could vary within a suitable range that would still allow high visibility of those sections 15,16.

The sections 15,16 extend as a diagonal stripe across the width of the tape's front surface 11, extending substantially from the first edge 13 to the second edge 14. Consequently, each of the first 15 and second 16 sections resembles a parallelogram. Each section 15,16 is defined along two of its sides by a borderline 18. Each borderline 18 is shared by the two adjacent sections. The borderlines 18 extend diagonally across the tape's width W. Each borderline 18 has one end that approaches the first edge 13 of the tape 10 at an acute angle A_{ac} relative to one of the adjacent sections. The opposite end of the borderline 18 approaches the second edge 14 of the tape 10 at an obtuse angle A_{ob} relative to that same section.

The tape's sections 15,16 are positioned in a side by side relationship to each other extending along the longitudinal axis L of the tape 10, with the borderlines 18 extending between the sections 15,16. Furthermore, the positioning of the first 15 and second 16 sections is alternated such that a first section 15 is adjacent to a second section 16 which is next to another first section 15 so that each first section 15 is flanked by second sections 16, and each second section 16 is flanked by first sections 15.

As a result, the specific pattern on the front surface 11 of the tape comprises alternating sections of brightly colored material and illuminative material, forming diagonal stripes. Since the brightly colored sections 16 are highly visible during the daytime and the illuminative sections 15 are highly visible during the nighttime, the overall visual effect results in a highly visible striped pattern on the tape's surface 11.

In a preferred embodiment the back surface 12 is a brightly colored material and is highly visible during daytime hours. However, in an alternate embodiment, the pattern of alternating colors and sections 15,16 could be included on both the back 12 and front 11 surfaces of the tape 10.

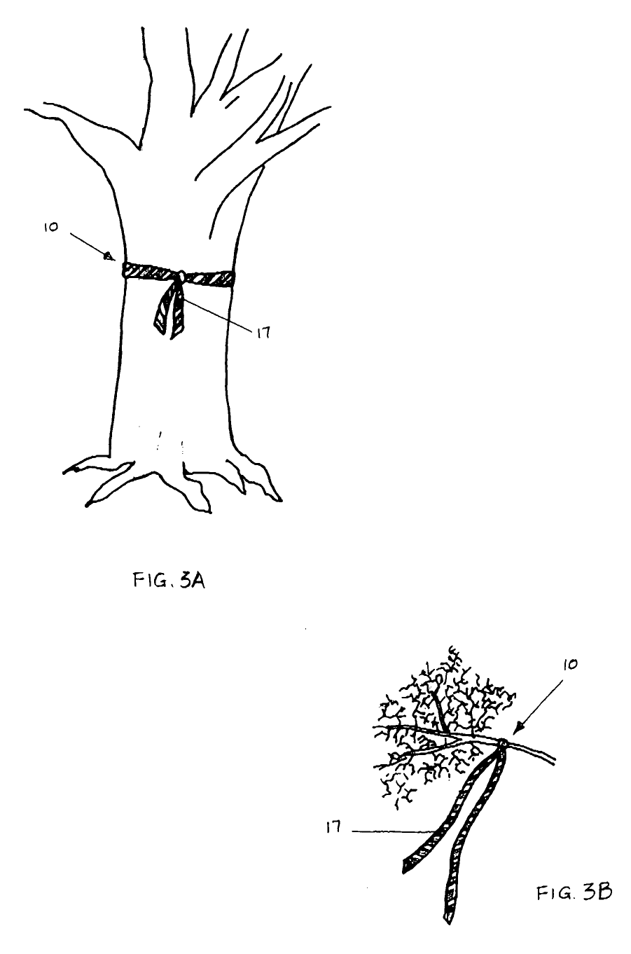

In a preferred use, the tape 10 of the trail marking device 1 is cut to the desired length and secured in place on a selected support as shown in FIGS. 3A and 3B.

Initially, the tape 10 is wound onto the storage spool 50. To install, a selected portion 17 of the tape 10 is unwrapped from the spool 50. The selected portion 17 includes the desired length of tape 10 to be installed. The selected portion 17 is broken or cut from the remaining tape 10 at a position along the tape 10 coinciding with the desired length. The selected portion 17 of tape 10 is then mounted on the support as shown in FIGS. 3A and 3B by wrapping the tape 10 around the support with the pattern facing away from the support and tying the ends of the selected portion 17 together so that the tape 10 is secured to the support. For example, when marking a trail in a wooded area, the tape 10 can be easily installed on trees or limbs by wrapping the selected portion 17 around the tree or limb and tying it in place.

Although tying the tape 10 to the support is a simple and preferred means by which to secure the tape 10 to a support, other suitable means, including nails, tacks, staples or adhesives could be used instead.

The trail marking device of the present invention has the advantage of being highly visible during both daytime and nighttime hours due to the combined pattern of the brightly colored and illuminative sections on the surface of the tape. The specific pattern created by the placement of the differently colored sections makes the device highly visible despite any twisting or curling of the tape.

Additionally, the tape of the trail marking device is able to retain high visibility despite the effects of weather and vandalism, thereby acting as a resilient marker which can be positively identified in both the dark and light hours of the day. While the tape creates a substantially permanent and positive means by which to identify a marked trail, the tape can otherwise be readily removed without damaging the environment in the event it is necessary to do so.

Although the present invention has been described in considerable detail with reference to certain preferred versions thereof, other versions are possible. Therefore, the spirit and scope of the appended claims should not be limited to the description of the preferred versions contained herein.

1. A trail marking device comprising:
an elongated sheet of pliable tape comprising front and back surfaces, first and second edges, and a longitudinal axis, wherein said front surface is disposed opposite said back surface, said front and back surfaces are bounded on one side by said first edge and on an opposite side by said second edge, and said longitudinal axis extends generally parallel to said first and second edges;
a pattern on at least one of said front and back surfaces;
said pattern comprises a series of first and second sections along the longitudinal axis of the pliable tape; and
each said first section comprising an illuminative material and each said second section comprising a brightly colored material,
wherein said pliable tape is frangible.

2. The trail marking device of claim 1, wherein said series of said first and second sections are alternately positioned along said longitudinal axis of the tape.

3. The trail marking device of claim 2, wherein each of said first sections is adjacent to at least one of said second sections.

4. The trail marking device of claim 3, wherein said pliable tape further comprising a borderline between each of said adjacent first and second sections, such that said borderline extends between the first and second edges of the tape.

5. The trail marking device of claim 4, wherein one end of said borderline forms an acute angle in one of said first or second sections with the first edge of the tape and an opposite end of said borderline forms an obtuse angle in said one first or second sections with the second edge of the tape.

6. The trail marking device of claim 3, wherein said first and second sections extend diagonally across the longitudinal axis of the tape.

7. The trail marking device of claim 1, wherein said brightly colored material being a fluorescent material.

8. The trail marking tape of claim 1, wherein the surface opposite one of said front and back surfaces comprising said pattern including a brightly colored material.

9. The trail marking tape of claim 1, further comprising a storage spool, wherein said elongated sheet of pliable tape is stored on said storage spool; and in use a selected section of the pliable tape is removed from the storage spool, severed from the sheet of pliable tape remaining on the storage spool and attached directly to a support.

10. The trail marking tape of claim 1, wherein said illuminative material comprises a light reflecting material.

11. A trail marking device comprising:
an elongated sheet of pliable tape comprising front and back surfaces, first and second edges, and a longitudinal axis, wherein said front surface is disposed opposite said back surface, said front and back surfaces are bounded on one side by said first edge and on an opposite side by said second edge, said longitudinal axis extends generally parallel to said first and second edges and said pliable tape is frangible;
a storage spool, wherein said elongated sheet of pliable tape is stored on said storage spool;
a pattern on at least one of said front and back surfaces, wherein said pattern comprises a series of first and second sections positioned alternately along the longitudinal axis of the pliable tape, such that each of said first sections is adjacent to at least one of said second sections;
each said first section comprising an illuminative material and each said second section comprising a brightly colored material, wherein said brightly colored material includes a fluorescent material;
the surface opposite one of said front and back surfaces comprising said pattern comprises a brightly colored material; and
said pliable tape further comprising a borderline extending between each of said adjacent first and second sections, wherein said borderline extends between said first and second edges such that one end of said borderline forms an acute angle in one of said first or second sections with the first edge of the tape and an opposite end of said borderline forms an obtuse angle in said one first or second sections with the second edge of the tape;
wherein to use said trail marking device, a free end of the tape is unwound from said storage spool to at least a desired length, a selected portion comprising the desired length is severed from the tape remaining on said storage spool, said selected portion is positioned on a support with said pattern facing outwardly from the support, and said selected portion is secured to the support.

12 (canceled).
